(19) United States
(12) Patent Application Publication
(10) Pub. No.: US 2014/0325770 A1
(43) Pub. Date: Nov. 6, 2014

(54) Leveling Device

(71) Applicant: Haigh Australia Pty Ltd, Darra, Queensland (AU)

(72) Inventors: Leslie James Somers, Darra (AU); Ty Gerard Hermans, Darra (AU)

(73) Assignee: Haigh Australia PTY Ltd, Darra, Queensland (AU)

(21) Appl. No.: 14/360,327

(22) PCT Filed: Dec. 21, 2012
(86) PCT No.: PCT/AU2012/001570

§ 371 Date: May 23, 2014

(30) Foreign Application Priority Data
Dec. 23, 2011 (AU) 2011905408

(51) Int. Cl. B60T 3/00

(52) U.S. Cl. CPC B60T 3/00
USPC 14/69.5

(57) ABSTRACT

An improved ramp assembly for leveling of wheeled vehicles such as campervans, caravans, motor homes, trailers and the like when parked on uneven ground.

### FIELD OF THE INVENTION

The present invention relates to an improved device for leveling of wheeled vehicles including campervans, caravans, motor homes, trailers and the like when parked on uneven ground. In particular the present invention relates to an improved ramp assembly for leveling of recreational vehicles including dual axle vehicles.

### BACKGROUND OF THE INVENTION

With increasing popularity of recreational vehicles such as caravans, motor homes, camper trailers and the like, there comes a greater need for safe, efficient and cost effective means for leveling or elevating a select wheel or wheels of the vehicle in a range of terrains.

When a recreational vehicle such as a caravan or motor home is parked for use as living quarters it is desirable that it be in a level, substantially horizontal position for the comfort of the occupants and to allow proper functioning of gravity fed taps and other appliances.

When a recreational vehicle is parked on uneven ground, each of its wheels may be resting on sloping or uneven ground. Various types of devices and systems have been used to level and support recreational vehicles including hydraulic jacks mounted on the bottom of the vehicle and which are pivoted to swing from a horizontal storage position to a vertical operating position from which a ram extends. Such devices however are limited to the extent that in limited space beneath the vehicle, the ram may not be able to extend sufficiently to rotate the jack into a suitable operating position before contacting the ground. If the jacks are not locked in a proper operating position, there is a risk of the vehicle shifting in windy conditions or movement of people within the vehicle.

It is known to level vehicles by positioning an article such as a brick or plurality of bricks or a substantially wedge-shaped device under one or more of the wheels of the vehicle. This approach has the drawback that if a number of bricks are used, it is problematic to try to drive a wheel over a stack of bricks to arrive at a desired height, and the bricks may not be sufficiently stable.

In order to address this deficiency, some devices are provided in plastic which try to simulate a stack of bricks. Such devices however are limited to the extent that the greater the degree of height adjustability that is to be supplied, the longer the device must be. This presents a practical problem for vehicles, for example dual-axle vehicles, where there is limited space between adjacent wheels. A plastic device which would provide the necessary height for leveling may be too long to fit between adjacent wheels of a dual axle vehicle.

One attempt to address such a practical problem has been to use a single unit or two or more units that are combined by stacking to achieve a desired height by posts and pins. A particular drawback of such a system is that each unit has a height of about 4 to 6 cm, making it difficult in some instances for a vehicle wheel to be moved up and eventually onto the top surface of the unit or, onto the top surface of a stack of units. The greater the height of stacked units the more difficult and dangerous the process becomes particularly where the surface is unstable.

It is therefore an object of the present invention to address one or more disadvantages of the prior art. In particular, one object of the invention is to provide an alternative leveling system which is practical and cost effective.

It should be understood that any reference to prior art does not constitute an admission of common general knowledge.

### SUMMARY OF THE INVENTION

In the present invention there is disclosed an improved leveling ramp assembly for use in leveling a wheeled vehicle in a parked condition, the ramp assembly including:
at least a first and a second releasably interconnectable ramp bodies, wherein the first ramp body includes:
   a ride-on platform having a forward end and a rearward end, and
   a ground engaging base,
   wherein the ride-on platform and base are interconnected by a support wall whereby the wall is configured such that the ride-on platform slopes gradually upwards from the forward to rearward ends,
   the platform having a plurality of stepped portions for adjusting the level of a wheel of the vehicle between the forward and rearward ends thereof, and
   wherein the first ramp body is sized to allow location of the forward end immediately adjacent a wheel in use;
the second ramp body including:
   a second ride-on platform having a forward end and a rearward end,
   a ground engaging base, and
   a support wall interconnecting the base and ride-on platform,
   a stop surface adjacent the rearward end thereof against which a surface of a wheel of the vehicle can stably rest;
releasable mating interlocking components on the at least first and second ramp bodies to allow releasable locking of a rearward end of the first ramp body to the forward end of the second ramp body in an assembled condition;
wherein the second ramp body is configured to provide a substantially continuous ride-on platform when the second ramp body is interconnected to the first ramp body in an assembled condition, and
wherein when a wheel of a vehicle is displaced over a portion of the ride-on platform of the first ramp body, the mating interlocking component of the first ramp body is exposed sufficiently to allow releasable interlocking of the second ramp body to the first ramp body in an assembled condition.

In a related aspect of the present invention there is disclosed an improved leveling ramp assembly for use in leveling a dual-axle wheeled vehicle in a parked condition, the ramp assembly including:
at least a first and a second releasably interconnectable ramp bodies, wherein the first ramp body includes:
   a ride-on platform having a forward end and a rearward end, and
   a ground engaging base,
   wherein the ride-on platform and base are interconnected by a support wall whereby the wall is configured such that the ride-on platform slopes gradually upwards from the forward to rearward ends,
   the platform having a plurality of stepped portions for adjusting the level of a wheel of the vehicle between the forward and rearward ends thereof, and
   wherein the first ramp body is sized to allow location of the forward end immediately adjacent a wheel in use, and between adjacent wheels of the dual axle vehicle;
the second ramp body including:
   a second ride-on platform having a forward end and a rearward end,
   a ground engaging base, and
   a support wall interconnecting the base and ride-on platform,
   a stop surface adjacent the rearward end thereof against which a surface of a wheel of the vehicle can stably rest;
releasable mating interlocking components on the at least first and second ramp bodies to allow releasable locking of a rearward end of the first ramp body to the forward end of the second ramp body in an assembled condition;
wherein the second ramp body is configured to provide a substantially continuous ride-on platform when the second ramp body is interconnected to the first ramp body in an assembled condition, and
wherein when a wheel of a dual axle vehicle is displaced over a portion of the ride-on platform of the first ramp body, the mating interlocking component of the first ramp body is exposed and sufficient space is available between adjacent wheels of a dual axle vehicle to allow releasable interlocking of the second ramp body to the first ramp body in an assembled condition.

The assembly of the present invention represents an advance over the prior art because it provides a practical means of efficient height adjustability and stability for leveling a wheeled vehicle and a dual axle vehicle. In particular the present assembly represents a departure from the prior art to the extent that a first ramp body can be positioned between adjacent wheels on a dual axle vehicle and once the vehicle has moved over at least a forward part of the ride-on platform of the first ramp body, the second ramp body can be assembled to the rearward end of the first ramp body to allow the wheels to benefit from multiple height levels in a stable and efficient way.

The ride-on platform of the at least first and second ramp bodies can include a series of parallel spaced apart longitudinal channels extending between the forward and rearward ends thereof to add strength and stability to the at least first and second ramp bodies.

The ride-on platform of the at least first and second ramp bodies can include a series of transverse ribs spaced apart along the platform forming a tread with the longitudinal channels to further improve gripping between the wheels and platform and to assist the placement of chock member configured to mate with a portion of the first and/or second ramp bodies wherein the chock member acts as a stop surface for further stabilsing the wheel when the wheel is effectively positioned on the platform.

The mating interlocking components can include:

a substantially u-shaped recess ending in an upstanding lip adjacent the rearward end of the first ramp body, the recess extending transverse to the longitudinal direction of the ride-on platform; and
a complimentary engaging skirt and inverted u-shaped recess located at a forward end of the second ramp body, whereby the skirt and inverted u-shaped recess extend beneath the ride-on platform of the second ramp body;
wherein the skirt is adapted for releasable mating engagement within the u-shaped recess of the first ramp body, and the upstanding lip of the first ramp body is located within the inverted u-shaped recess of the second ramp body in an assembled condition.

The assembly can include one or more ramp bodies intermediate the first and second ramp bodies.

In a related aspect of the present invention there is provided a leveling device for use in leveling a wheeled vehicle, comprising:
a first ramp body having an upper ride-on platform and a base, the platform and base being interconnected by a wall which is configured so that the ride-on platform tapers from a forward region to a rearward region so as to be substantially
in the shape of a portion of a wedge; and
a coupling formed at or adjacent the rearward region,
   in which the coupling is adapted for releasable coupling with a complimentary coupling of another such leveling device;
a second ramp body having a ride-on platform and a complementary coupling formed at or adjacent the forward region thereof
   in which the respective couplings are releasably interconnected to allow placement of the first ramp body between adjacent wheels and thereafter allow assembly of the second ramp body to the first ramp body when the wheeled vehicle has moved along the ride-on platform of the first ramp body towards the rearward region of the first ramp body.

In a further related aspect of the present invention there is provided a leveling device for use in leveling a wheeled vehicle, comprising:
a first ramp body having an upper ride-on platform and a base separated by a wall which is configured so that the ride-on platform tapers from a forward region to a rearward region so as to be substantially in the shape of a portion of a wedge; and
a coupling formed at or adjacent the rearward region,
   in which the coupling is adapted for releasable coupling with a complimentary coupling of another such leveling device.

The ride-on surface of the first ramp body can include at least one step portion providing a first plateau region for receiving a wheel of the vehicle in a first height level.

It is preferred that the first ramp body is integrally formed.

It is preferred that each coupling is formed integrally with the respective ramp body.

In yet a further aspect, the present invention provides a leveling assembly for a dual-axle vehicle comprising at least two releasably connectable ramp bodies, wherein the first ramp body includes a forward end and a rearward end separated by an upper ride-on platform, the platform being supported by a tapering wall mounted to a ground engaging base, wherein the wall tapers from the forward end to the rearward end so that the rearward end is higher relative to the forward end, wherein the second ramp body has a forward end having at least a partial step portion and plateau and a rearward end ending in a stop face, and wherein the a least first and second ramp bodies include releasable mating components so that in an assembled condition the upper ride-on platform is continuous and allows a wheel of a dual axle vehicle improved height adjustment and stability.

In one embodiment, the second ramp body can include a handle located at or near the rearward end. The second ramp body can further include a recess or cavity beneath the ride on platform for providing a storage member within the recess or cavity. In one embodiment, the storage member is in the form of a storage draw or the like in slideable engagement with the recess or cavity. In a further embodiment, the storage member is in the form of a clip or clips adapted to releasably engage with the recess or cavity.

In a further related aspect of the present invention, there is disclosed a method of leveling a dual-axle vehicle in a parked condition including:
providing an improved leveling ramp assembly including:
   at least a first and second releasably interconnectable ramp bodies, wherein the first ramp body includes:
      a ride-on platform having a forward end and a rearward end,
      a ground engaging base portion, and
      a wall interconnecting the base portion and the ride-on platform, whereby the ride-on platform slopes gradually upwards from the forward to rearward ends, a plurality of stepped portions in the ride-on platform for receiving a wheel of a vehicle in different height locations, and
      wherein the first ramp body is sized to locate in substantial alignment with and between adjacent wheels of the dual axle vehicle so that one wheel can move over the ride-on platform starting from the forward end;
   the second ramp body including:
      a ride-on portion having a forward end and a rearward end, and a step portion adjacent the forward end,
      a base interconnected to the ride-on portion by a supporting wall, wherein the forward end is configured to provide a substantially continuous ride-on platform when the second ramp body is interconnected to the first ramp body in an assembled condition, wherein the second ramp body has a stop surface adjacent the rearward end thereof against which a surface of a wheel of the vehicle can stably rest;
   releasable mating interlocking components on the at least first and second ramp bodies to allow releaable locking of a rearward end of the first ramp body to the forward end of the second ramp body;
      wherein the method includes placing the forward end of the first ramp body beneath a first wheel and between the first and second wheel of the dual-axle wheels; moving the wheel over the ride-on platform, wherein when the wheel of a dual axle vehicle is displaced over a portion of the ride-on platform of the first ramp body sufficient space is formed between the tandem wheels, whereby the mating interlocking components are releasably engaged in an assembled condition to provide efficient height adjustment for dual axle vehicles.

It is preferred that the improved leveling ramp assembly can receive 1.8 kg in weight.

It is preferred that the improved leveling ramp assembly can nest for easy storage into a space of 140 mm×570 mm×250 mm.

The assembly and method according to the present invention makes an advance of the prior art because it allows for a first section to easily fit in the space between adjacent tandem wheels, and once the wheels are positioned on a first plateau level of the first ramp body, the second ramp body can be releasably connected to allow the wheels to benefit from further height levels.

### BRIEF DESCRIPTION OF THE DRAWINGS

For a better understanding of the invention, and to show how it may be carried into effect, embodiments of it are shown, by way of non-limiting example only, in the accompanying drawings. In the drawings:

FIG. 1 is a perspective view illustrating the first ramp body and the second ramp body of the present invention;

FIG. 2 is a perspective view illustrating the inter-operation of the first ramp body and the second ramp body of FIG. 1;

FIG. 3 is an elevational view of one side of one of the second ramp body of FIG. 1;

FIG. 4 is an underneath view of the second ramp body of FIG. 3;

FIG. 5 is an elevational view from the forward end of the second ramp body of FIG. 3;

FIG. 6 is an elevational view from the rearward end of the second ramp body of FIG. 3;

FIG. 7 is an elevational view of another side of the second ramp body of FIG. 3;

FIG. 8 is a plan view of the second ramp body of FIG. 3;

FIG. 9 is an elevational view of one side of the first ramp body of FIG. 1;

FIG. 10 is an underneath view of the first ramp body of FIG. 9;

FIG. 11 is an elevational view, from the forward end of the first ramp body of FIG. 9;

FIG. 12 is an elevational view from the rearward end of the first ramp body of FIG. 9; and

FIGS. 13 a-d show the method of use for installing the improved leveling ramp assembly.

### DESCRIPTION OF PREFERRED EMBODIMENTS OF THE INVENTION

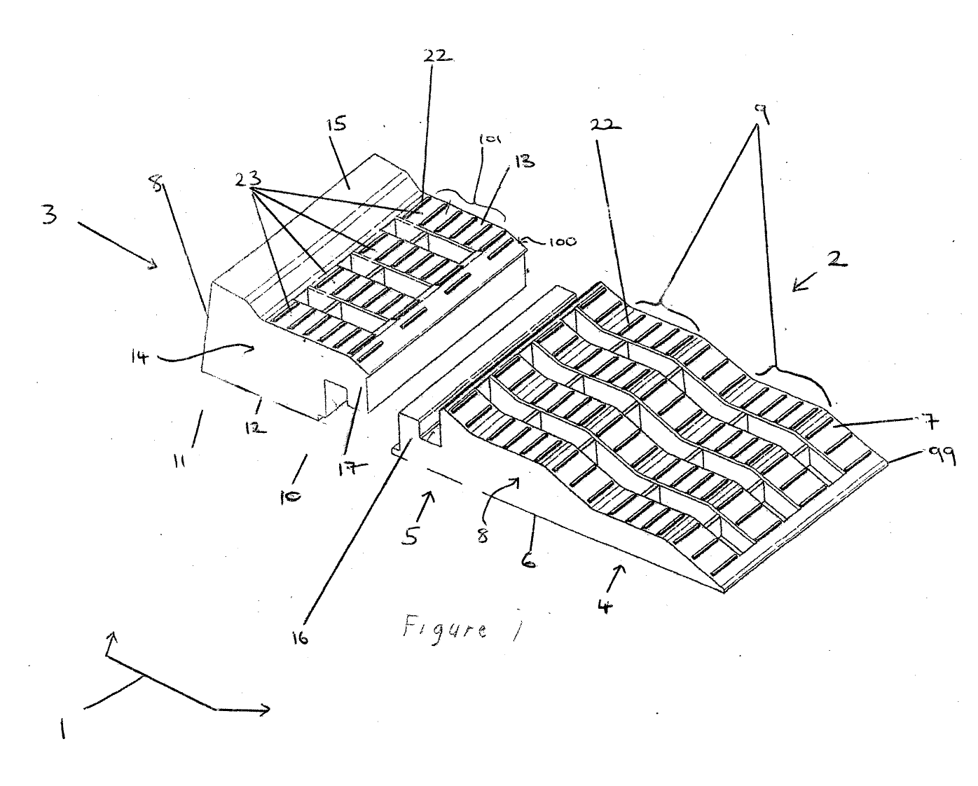

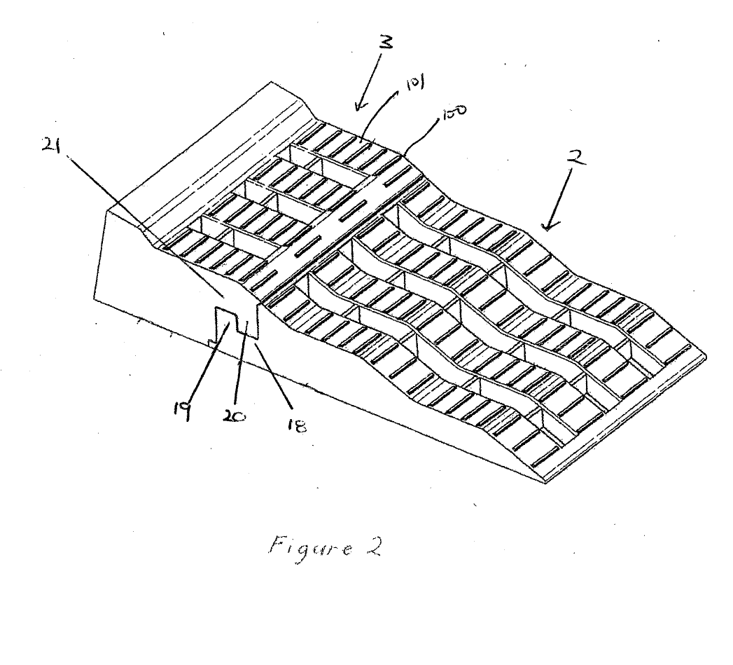

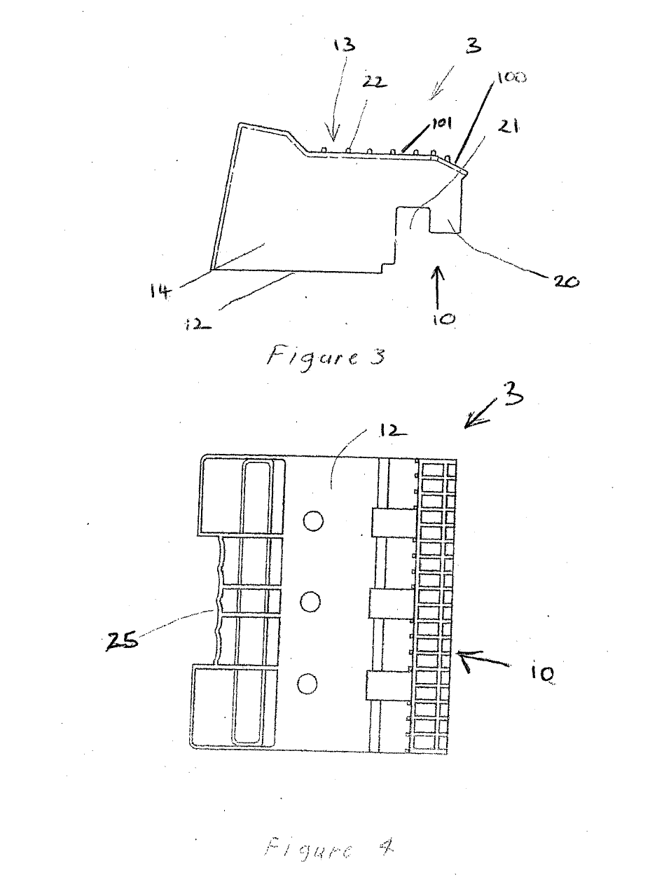

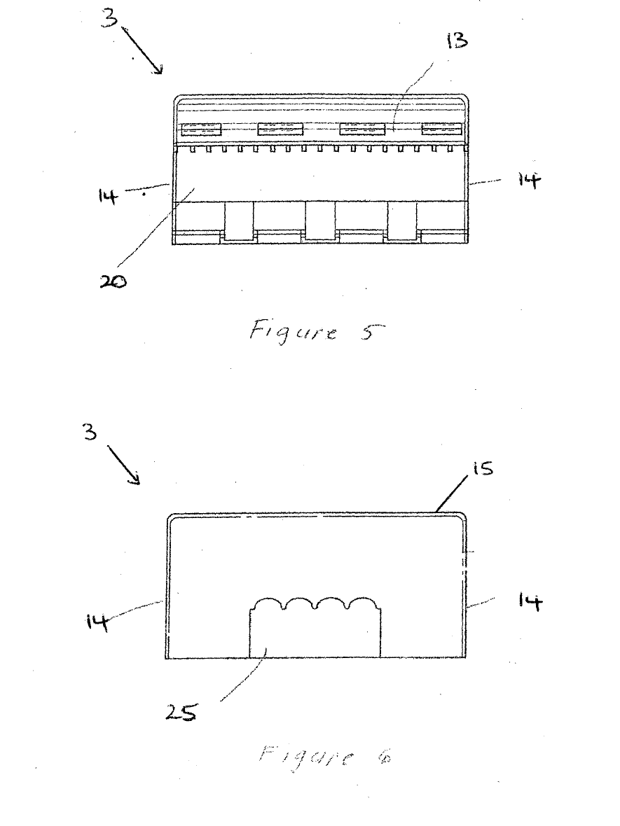

Referring to FIG. 1, there is shown an improved leveling ramp assembly 1 in a non-assembled condition which is used in leveling a dual axle recreational vehicle in a parked condition in an assembled condition (FIG. 2). The ramp assembly as shown in FIGS. 1 and 2 includes a first ramp body 2 which is generally wedge shaped, which is releasably connectable to a second ramp body 3. The first ramp body 2 includes a ride-on platform having a forward end 4 and a rearward end 5. The ride-on platform is supported by a ground engaging base 6 and wall 8. As shown, the wall is configured such that the ride-on platform 7 slopes gradually upwards from the forward end 4 to the rearward end 5 of the first ramp body 2.

As shown, the ride-on platform 7 of the first ramp body 2 has a plurality of stepped portions 9, which allow for adjusting height of a wheel (see particularly FIGS. 13a to 13d) of a vehicle between the forward end 4 and rearward end 5 thereof. As best seen in FIG. 13a, the first ramp body 2 is sized to locate between adjacent wheels of the dual axle vehicle with the a lip portion 99 of the forward end adapted to be placed immediately beneath one wheel so that the wheel can move over the ride-on platform 7 starting from the forward end 4.

The second ramp body 3 includes a further ride-on portion having a forward end 10 and a rearward end 11, and a ground engaging base portion 12 interconnected to the ride-on portion by a wall 14. The forward end 10 of the second ramp body is configured to provide a substantially continuous ride-on platform 13 when the second ramp body 3 is interconnected to the first ramp body 2 in an assembled condition (FIG. 2). Between the forward and rearward ends 10, 14 there is shown a further step 100 ending in a plateau 101 for further height adjustment in an assembled condition. Adjacent the rearward end 11 of the second ramp body 3 there is shown a stop surface 15 against which a surface of a wheel of the vehicle can stably rest (see FIG. 13d).

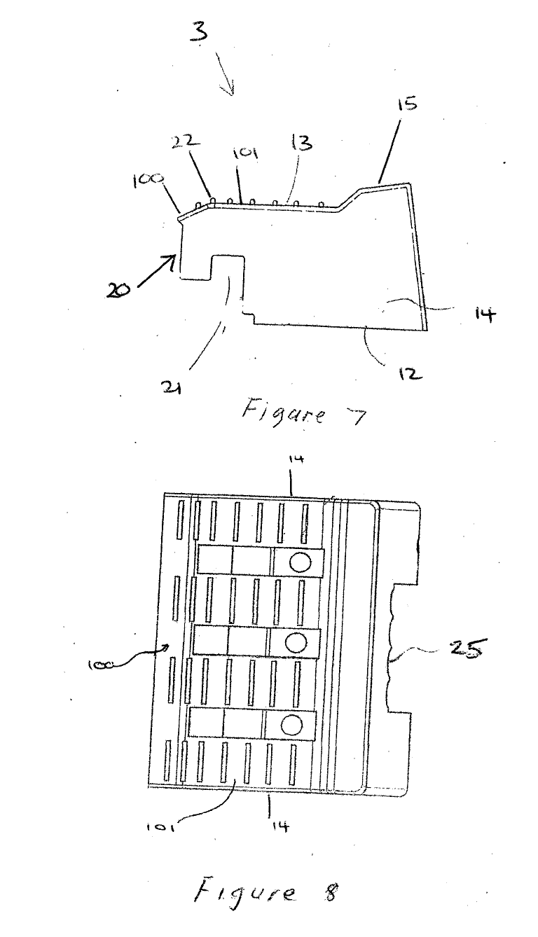

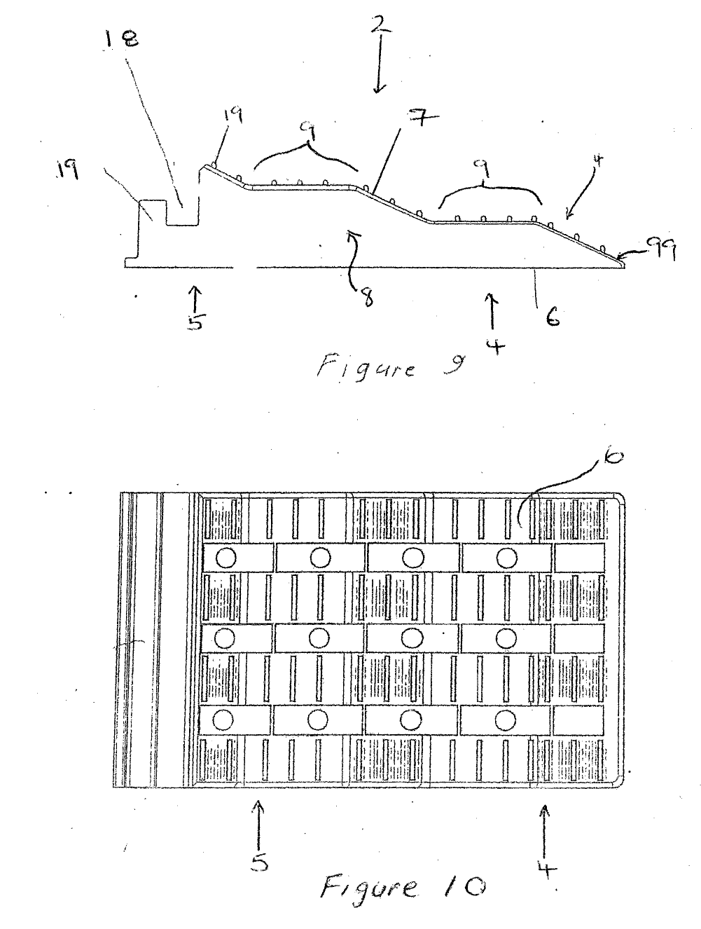

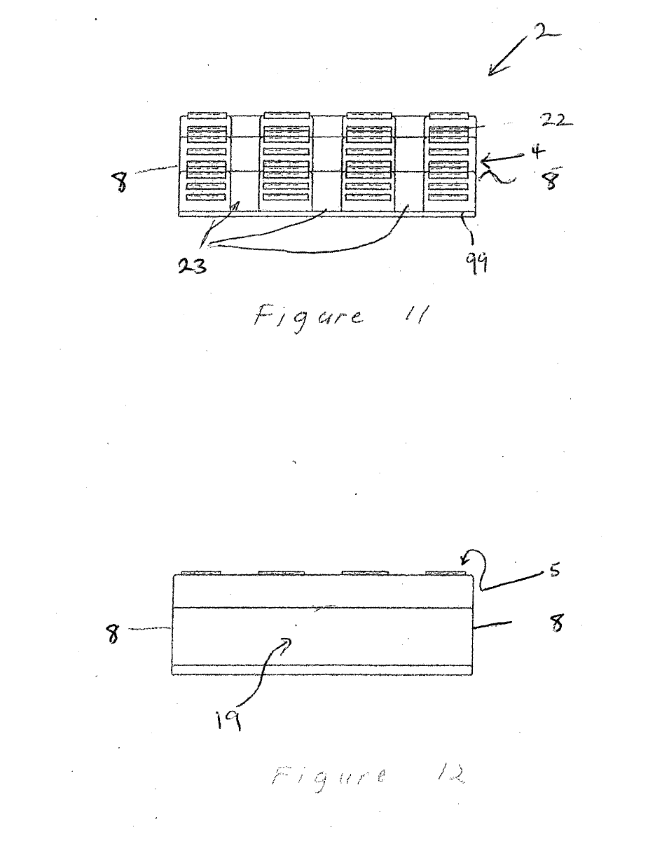

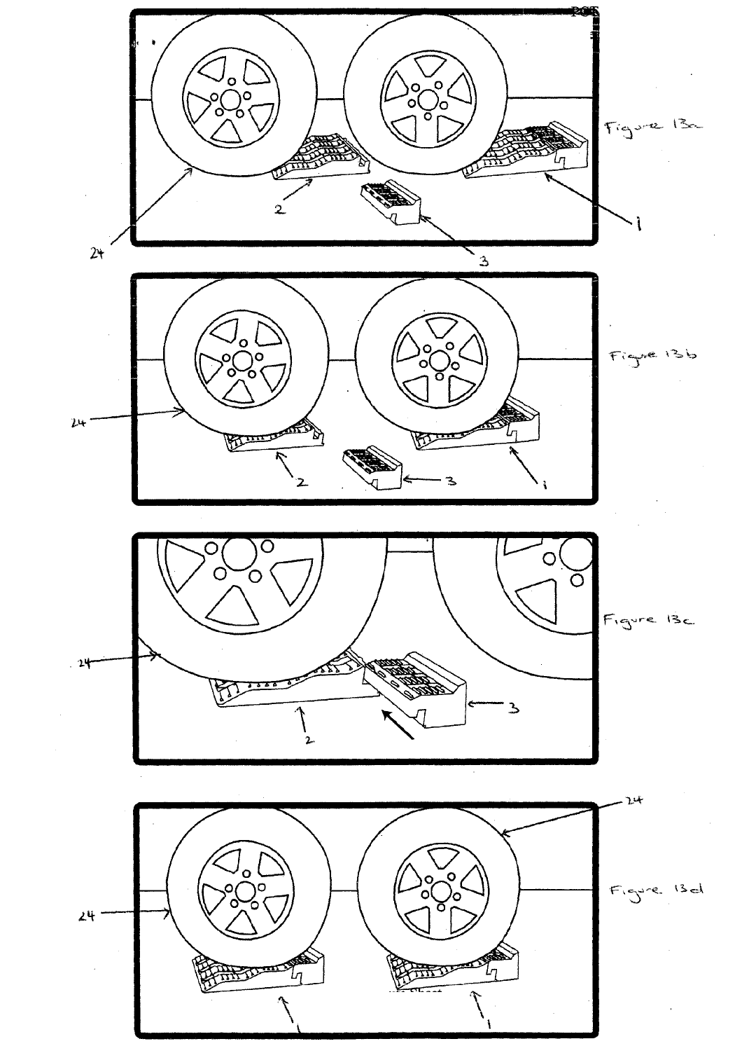

As best seen in FIGS. 1 and 2, the first and second ramp bodies 2, 3 include releasable mating interlocking components 16, 17 on the first ramp body 2 and second ramp body 3 respectively to allow releasable locking of a rearward end 5 of the first ramp body 2 to the forward end 10 of the second ramp body 3. As shown in FIG. 9 the mating interlocking components include a substantially u-shaped recess 18 ending in an upstanding lip 19 adjacent the rearward end 5 of the first ramp body 2, the recess extending transverse to the longitudinal direction of the ride on platform 7. FIGS. 3 and 7 show a complementary engaging skirt 20 and inverted u-shaped recess 21 located at a forward end 10 of the second ramp body 3 allows for the skirt 20 and the inverted u-shaped recess 21 to extend beneath the ride-on platform 13 of the second ramp body 3. FIG. 2 shows the skirt 20 is adapted for mating engagement with the u-shaped recess 18 of the first ramp body 2 and the upstanding lip 19 of the first ramp body 2 is located within the inverted u-shaped recess 21 of the second ramp body 3 in assembled condition.

The ride-on platforms 7, 13 of the first ramp body 2 and the second ramp body 3 respectively include a series of spaced apart rib projections 22 sitting proud of the ride-on platform and extending transverse to the longitudinal direction of the platform whereby the projections assist gripping a surface of a wheel. In addition, the ride-on platforms 7, 13 of the at least first ramp body 2 and second ramp body 3 respectively include a series of parallel spaced apart longitudinal channels 23 extending between the forward and rearward ends thereof, whereby the channels provide strength and stability to the at least first and second ramp bodies 2, 3. The channels are divided into rectangular sections, each section including a circular pin which assists further gripping.

Referring to FIG. 2, there is shown the first ramp body 2 respectively interconnected with the second ramp body 3 wherein the mating interlocking components 16, 17 of the at least first ramp body 2 and second ramp body 3 respectively allow releasable assembly of the second ramp body 3 in an assembled condition to provide stable and efficient height adjustment for dual axle vehicles when a wheel 24 (FIG. 13 b, c) of a dual axle vehicle is displaced over a portion of the ride-on platform 7 of the first ramp body 2.

Referring to FIGS. 4, 6 and 8, the rearward end 11 of the second ramp body 3 includes a handle 25 allowing easy movement and control of placement of the body. In one embodiment (not shown) the second ramp body includes an internal chamber and rear opening for receiving a storage draw or the like in slidable engagement. The handle can be mounted to the draw. In a further embodiment (not shown), the internal chamber and rear opening releasably engage with a clip or clips or the like.

As best seen in FIGS. 13 a to 13 d, there is further shown a method of leveling a wheeled vehicle using the assembly shown in FIGS. 1 and 2. In particular, the lip 99 of the forward end of the first ramp body 2 is placed immediately adjacent to a wheel 24, and the platform is aligned with and between adjacent wheels of a dual axle vehicle (FIG. 13a). In the method, the vehicle is moved so that wheel 24 of the dual axle vehicle is driven over one or more steps of the ride on platform 7 (FIG. 13b) to adjust height and level of the vehicle. Once the wheel 24 is positioned on a desired stepped portion 9 of the first ramp body 2, space is provided between the adjacent wheels to allow assembly of the second ramp body.

In an assembled condition as shown in FIG. 2 and FIG. 13c and d, the second ramp body 3 is interconnected with the first ramp body 2 (FIG. 13c) by releasable interlocking components 16 and 17. Once assembled the vehicle can be further driven up to the step portion on the second ramp body 3 thereby improving efficient leveling of the wheeled vehicle (FIG. 13d).

The leveling device of the present invention can be manufactured from plastic material or other materials using known methods including casting, moulding and machining.

Preferred materials for the first ramp body 2 and the second ramp body 3 are plastics which can be cast, moulded or machined.

In a preferred embodiment the improved leveling ramp assembly has capacity for five tonnes. In a further preferred embodiment, the improved leveling ramp assembly can level a wheel of 100 mm to up to 250 mm in width.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

A reference to any prior art in this specification is not, and should not be taken as, an acknowledgment or any form of suggestion that the referenced prior art forms part of the common general knowledge, whether in Australia or elsewhere.

Throughout this specification, the words “comprise”, “comprised”, “comprising” and “comprises” are to be taken to specify the presence of stated features, integers, steps or components but does not preclude the presence or addition of one or more other features, integers, steps, components or groups thereof.

In the claims, each dependent claim is to be read as being within the scope of its parent claim or claims, in the sense that a dependent claim is not to be interpreted as infringed unless its parent claims are also infringed.

1. An improved leveling ramp assembly for use in leveling a wheeled vehicle in a parked condition, the ramp assembly including:
at least a first and a second releasably interconnectable ramp bodies, wherein the first ramp body includes:
a ride-on platform having a forward end and a rearward end, and
a ground engaging base,
wherein the ride-on platform and base are interconnected by a support wall whereby the wall is configured such that the ride-on platform slopes gradually upwards from the forward to rearward ends,
the platform having a plurality of stepped portions for adjusting the level of a wheel of the vehicle between the forward and rearward ends thereof, and
wherein the first ramp body is sized to allow location of the forward end immediately adjacent a wheel in use;
the second ramp body including:
a second ride-on platform having a forward end and a rearward end,
a ground engaging base, and
a support wall interconnecting the base and ride-on platform,
a stop surface adjacent the rearward end thereof against which a surface of a wheel of the vehicle can stably rest;
releasable mating interlocking components on the at least first and second ramp bodies to allow releasable locking of a rearward end of the first ramp body to the forward end of the second ramp body in an assembled condition;
wherein the second ramp body is configured to provide a substantially continuous ride-on platform when the second ramp body is interconnected to the first ramp body in an assembled condition, and
wherein when a wheel of a vehicle is displaced over a portion of the ride-on platform of the first ramp body, the mating interlocking component of the first ramp body is exposed and sufficient space is available to allow releasable interlocking of the second ramp body to the first ramp body in an assembled condition.

2. The improved leveling ramp assembly according to claim 1 wherein the ride-on platform of the at least first and second ramp bodies include a series of parallel spaced apart longitudinal channels extending between the forward and rearward ends thereof to add strength and stability to the first and second ramp bodies.

3. The improved leveling ramp assembly according to claim 2 wherein the ride-on platform of the at least first and second ramp bodies include a series of transverse ribs spaced apart along the platform forming a tread with the longitudinal channels to further improve gripping between the wheels and platform.

4. The improved leveling ramp assembly according to claim 1 wherein the assembly further includes a chock member configured to mate with a portion of the first and/or second ramp bodies wherein the chock member acts as a stop surface for further stabilsing the wheel when the wheel is effectively positioned on the platform.

5. The improved leveling ramp assembly according to claim 1 wherein the mating interlocking components can include:
a substantially u-shaped recess ending in an upstanding lip adjacent the rearward end of the first ramp body, the recess extending transverse to the longitudinal direction of the ride-on platform; and
a complimentary engaging skirt and inverted u-shaped recess located at a forward end of the second ramp body, whereby the skirt and inverted u-shaped recess extend beneath the ride-on platform of the second ramp body;
wherein the skirt is adapted for releasable mating engagement within the u-shaped recess of the first ramp body, and the upstanding lip of the first ramp body is located within the inverted u-shaped recess of the second ramp body in an assembled condition.

6. The improved leveling ramp assembly according to claim 1 wherein the assembly can include one or more ramp bodies intermediate the first and second ramp bodies.

7. (canceled)

8. A leveling device for use in leveling a wheeled vehicle, comprising:
a first ramp body having an upper ride-on platform and a base separated by a wall which is configured so that the ride-on platform tapers from a forward region to a rearward region so as to be substantially in the shape of a portion of a wedge; and
a coupling formed at or adjacent the rearward region,
in which the coupling is adapted for releasable coupling with a complimentary coupling of another such leveling device.

9. A leveling device for use in leveling a wheeled vehicle according to claim 8 wherein the ride-on surface of the first ramp body can include at least one step portion providing a first plateau region for receiving a wheel of the vehicle in a first height level.

10. A leveling device for use in leveling a wheeled vehicle according to claim 8 wherein the first ramp body is integrally formed.

11. A leveling device for use in leveling a wheeled vehicle according to claim 8 wherein each coupling is formed integrally with the respective ramp body.

12. A leveling device as claimed in claim 8, in which the coupling is formed at a first region or a second region which is substantially planar.

13. A leveling device as claimed in claim 8 in which a tapering surface of the body carries at least one plateau.

14. A leveling device as claimed in claim 8 in which the body is integrally formed.

15. A leveling device as claimed in claim 8 in which each coupling is formed integrally with the body.

16. A leveling assembly for a dual-axle vehicle comprising at least two releasably connectable ramp bodies, wherein the first ramp body includes a forward end and a rearward end separated by an upper ride-on platform, the platform being supported by a tapering wall mounted to a ground engaging base, wherein the wall tapers from the forward end to the rearward end so that the rearward end is higher relative to the forward end, wherein the second ramp body has a forward end having at least a partial step portion and plateau and a rearward end ending in a stop face, and wherein the a least first and second ramp bodies include releasable mating components so that in an assembled condition the upper ride-on platform is continuous and allows a wheel of a dual axle vehicle improved height adjustment and stability.

17. A leveling device for use in leveling a wheeled vehicle according to claim 16 wherein the second ramp body include a handle located at or near the rearward end.

18. A leveling device for use in leveling a wheeled vehicle according to claim 16 wherein the second ramp body further include a recess or cavity beneath the ride on platform wherein structural support is provided on internal surfaces of the walls for receiving a storage member within the cavity.

19-21. (canceled)
